(19) United States
(12) Patent Application Publication
(10) Pub. No.: US 2012/0040184 A1
(43) Pub. Date: Feb. 16, 2012

(54) Method of Fabricating an Optical Fiber Preform

(75) Inventors: Louis-Anne de Montmorillon, Versailles (FR); Frans Gooijer, Eindhoven (NL); Pierre Sillard, Le Chesnay (FR)

(73) Assignee: DRAKA COMTEQ B.V., Amsterdam (NL)

(21) Appl. No.: 13/206,943

(22) Filed: Aug. 10, 2011

Related U.S. Application Data
(60) Provisional application No. 61/372,629, filed on Aug. 11, 2010.

(30) Foreign Application Priority Data
Aug. 10, 2010 (FR) 1056542

(51) Int. Cl. G02B 6/036; G02B 6/028; B32B 17/02; C03B 37/018; C03B 37/027

(52) U.S. Cl. 428/376; 65/412; 65/391; 65/399; 65/417; 428/392

(57) ABSTRACT

A method of manufacturing an optical fiber preform includes preparing from a first deposition tube a first rod that includes a central core and preparing from a second deposition tube a second rod that includes a buried trench. The method further includes fitting the second rod as a sleeve over the first rod. This disclosed method facilitates the manufacture of large-capacity fiber preforms using deposition benches having small and/or medium deposition capacity.

### CROSS-REFERENCE TO PRIORITY APPLICATIONS

This application claims the benefit of pending French Application No. 1056542 (filed Aug. 10, 2010, at the National Institute of Industrial Property (France)), which is hereby incorporated by reference in its entirety.

This application further claims the benefit of commonly assigned U.S. Provisional Patent Application Ser. No. 61/372,629, for Procede de Fabrication dune Preforme de Fibre Optique (filed Aug. 11, 2010), which is hereby incorporated by reference in its entirety.

### FIELD OF THE INVENTION

The present invention relates to the field of optical fibers and, more specifically, to a method of fabricating a preform for use in drawing an optical fiber that demonstrates greatly reduced bending losses.

### BACKGROUND

Conventionally, an optical fiber is drawn from an optical fiber preform in a fiber-drawing tower. The operation of drawing down an optical fiber to scale consists in placing the optical fiber preform vertically in a tower and drawing a strand of optical fiber from one end of the preform. For this purpose, a high temperature is applied locally to one end of the optical fiber preform until the silica is softened, and then the speed of fiber-drawing and the temperature are continuously regulated to control the diameter of the optical fiber.

An optical fiber (i.e., a glass fiber typically surrounded by one or more coating layers) conventionally includes an optical fiber core, which transmits and/or amplifies an optical signal, and an optical cladding, which confines the optical signal within the core. Accordingly, the refractive index of the core n_{c} is typically greater than the refractive index of the optical cladding n_{g} (i.e., n_{c}>n_{g}). In a single-mode optical fiber, the signal propagates in a fundamental LP01 mode that is guided in the fiber core, while the higher order modes (e.g., the LP11 mode or cladding mode) are guided a certain distance in the core-cladding assembly.

Conventionally, so-called “standard” single mode fibers (SSMFs) are used for land-based transmission systems. To facilitate compatibility between optical systems from different manufacturers, the International Telecommunication Union (ITU) defined a standard reference ITU-T G.652 with which a standard optical transmission fiber (i.e., a standard single-mode fiber or SSMF) should comply. The ITU-T G.652 recommendations (November 2009) and each of its attributes (i.e., A, B, C, and D) are hereby incorporated by reference.

Furthermore, the continuing development of optical fiber systems to reach the subscriber, known as fiber to the home (FTTH) or fiber to the curb (FTTC), places additional demands on optical fiber designs. Specifically, a major challenge for such FTTC or FTTH applications lies in reducing bending losses while conserving certain optical transmission parameters.

Accordingly, the ITU has defined a standard including the ITU-T G.657.A and ITU-T G.657.B recommendations for optical fibers for FTTH applications. In particular, the ITU-T G.657.A and ITU-T G.657.B recommendations include maximum bending loss requirements.

Recommendation G.657.A imposes limit values for bending losses but seeks above all to conserve compatibility with Recommendation G.652, particularly in terms of mode field diameter (MFD) and chromatic dispersion. In contrast, Recommendation G.657.B does not impose compatibility with Recommendation G.652 but does impose stricter limits on bending losses than Recommendation G.657.A1. Tables I and II (below) reproduce some of the constraints imposed by Recommendations G.652 and G.657 concerning bending losses (Table I) and optical transmission parameters (Table II).

TABLE I

| | | | | Maximum macrobending losses | | | |
|---|---|---|---|---|---|---|---|
| Radius | | Wavelength | (db) | (db) | (db) | (db) | (db) |
| (mm) | Turns | (nm) | G.652.D | G.657.A1 | G657.A2 | G.657.B2 | G.657.B3 |

| | | | | | | |
|---|---|---|---|---|---|---|
| 30 | 100 | 1550 | | | | |
| | | 1625 | 0.1 | | | |
| 15 | 10 | 1550 | | 0.25 | 0.03 | |
| | | 1625 | | 1 | 0.1 | |
| 10 | 1 | 1550 | | 0.75 | 0.1 | 0.3 |
| | | 1625 | | 1.5 | 0.2 | 0.1 |
| 7.5 | 1 | 1550 | | | 0.5 | 0.08 |
| | | 1625 | | | 1 | 0.25 |
| 5 | 1 | 1550 | | | | 0.15 |
| | | 1625 | | | | 0.45 |

TABLE II

| Parameter | Detail | Units | G.652.D | G657.A | G.657.B |
|---|---|---|---|---|---|
| MFD @ | Nominal | (μm) | 8.6-9.5 | 8.6-9.5 | 6.3-9.5 |
| 1310 nm | values | | | | |
| | Tolerance | | ±0.6 | ±0.4 | ±0.4 |
| Cut-off | Maximum | (nm) | 1260 | 1260 | 1260 |
| wavelength | | | | | |
| Chromatic | λ_{0 min} | (nm) | 1300 | 1300 | |
| dispersion | λ_{0 max} | (nm) | 1324 | 1324 | |
| coefficient | S₀ₘₐₓ | (ps/(nm² · | 0.092 | 0.092 | |
| | | km)) | | | |

Fabricating optical fibers that comply with the constraints of Recommendations G.652 and G.657 has become a major economic challenge.

The technology of making optical fibers with holes (i.e., holey fibers) enables excellent performance to be achieved in terms of bending losses, but that technology is complex and expensive to implement. Furthermore, at present, holey fibers are not suitable for use in FTTH systems because they are low-cost systems.

Commonly owned European Patent No. 1,845,399 (and its counterpart U.S. Pat. No. 7,587,111), and commonly owned European Patent No. 1,785,754 (and its counterpart U.S. Pat. No. 7,623,747), each of which is hereby incorporated by reference in its entirety, propose optical fiber profiles with a buried trench that enables bending losses to be limited, while conserving the optical transmission parameters of an SSMF.

A buried trench can be made during fabrication of the preform by incorporating dopants that lower the refractive index of the transmission material, typically silica. The most commonly used refractive-index-lowering dopant is fluorine. For example, the buried trench may be constituted by the tube of the primary preform that may be made of fluorine-doped silica, as described for example in commonly owned French Patent Application No. 2,896,795 (and its counterpart U.S. Patent Publication No. 2008/031582 A1), which are hereby incorporated by reference in their entirety. Nevertheless, fluorine-doped silica tubes do not enable refractive index profiles with deep buried trenches, nor do they enable the uniformity of the buried trench's refractive index to be thoroughly controlled. To ensure minimum bending losses without harming the optical transmission parameters imposed by Recommendation G.652, the uniformity of the buried trench's refractive index should be well controlled.

An optical fiber may be fabricated from an optical fiber preform that includes a primary preform constituted by a deposition tube of pure or doped silica in which layers of doped and/or pure silica are deposited in succession in order to form an inner cladding and a central core. Primary preforms of this nature are typically fabricated on a deposition bench. The primary preform is then overcladded or fitted with a sleeve to increase its diameter and form an optical fiber preform or final preform that is suitable for use in a fiber-drawing tower. In this context, the term “inner” cladding designates the cladding formed inside the deposition tube (e.g., a substrate tube) and the term “outer” cladding or “overcladding” designates the cladding formed outside the deposition tube. Deposition operations inside the deposition tube are typically chemical vapor depositions (CVD). A CVD deposition is performed by injecting mixtures of gas into a deposition tube and ionizing the mixtures. CVD-type depositions include modified chemical vapor deposition (MCVD), furnace chemical vapor deposition (FCVD), and plasma-enhanced chemical vapor deposition (PCVD).

After layers corresponding to the core and the inner cladding have been deposited, the deposition tube (i.e., including the deposition layers) is converted into a solid rod by an operation referred to as “collapsing.” This produces the primary preform that is constituted by a solid rod (i.e., a solid rod including the collapsed deposition tube, inner cladding layers, and core layers). The primary preform is then overcladded, generally with grains of natural silica for reasons of cost. Overcladding may be performed by plasma deposition in which grains of doped or pure natural silica are deposited by gravity and melted and vitrified on the periphery of the primary preform via a plasma torch.

The fluorine doping of an inner cladding layer of the primary preform may be achieved by PCVD-type depositions as described in European Patent No. 1,845,399 and/or European Patent No. 1,785,754. A PCVD-type deposition technique incorporates a large quantity of the fluorine dopants during deposition, which results in a buried trench that is deep and uniform.

Other techniques also exist for fabricating an optical fiber preform. For example, International Application No. WO 2007/009450 A1, which is hereby incorporated by reference in its entirety, relates to a method for producing large-core-diameter glass-fiber preforms.

European Patent No. 1,000,909, which is hereby incorporated by reference in its entirety, describes a method of fabricating an optical fiber preform in which a core-forming rod is inserted into a substrate tube that is subsequently overcladded. The substrate tube presents different doping zones obtained by outside vapor deposition (OVD), i.e., by vitrifying grains of silica mixed with a dopant gas. The substrate tube may in particular include a fluorine-doped zone. Nevertheless, an OVD-type deposition does not enable deep buried trenches to be achieved, nor does it enable the uniformity of the buried trench's refractive index to be well controlled.

International Application No. WO 2008/087132 (and its counterpart U.S. Patent Publication No. 2010/0034998) and International Application No. WO 2010/003856 (and its counterpart U.S. Patent Publication No. 2011/0100062), each of which is hereby incorporated by reference in its entirety, describe methods of fabricating fluorine-doped tubes for fitting as sleeves on primary preforms to manufacture optical fiber preforms. The documents propose making the fluorine-doped tube from a first substrate tube of fluorine-doped silica obtained by plasma outside deposition (POD) or OVD. A second tube of fluorine-doped silica is formed on the first by POD. The second tube has a dopant concentration that is different from that of the first tube. Thereafter, silica overcladding is applied to the assembly. The disclosed manufacturing technique produces a fluorine-doped tube with two zones of different doping. Nevertheless, such methods do not enable deep buried trenches to be achieved, nor does it enable the uniformity of the buried trench's refractive index to be well controlled.

U.S. Patent Publication No. 2007/0003198, which is hereby incorporated by reference in its entirety, describes a method of fabricating an optical fiber preform. That method proposes (i) first fabricating a rod forming the core by external vapor axial deposition (VAD) or OVD and (ii) then forming a buried cladding (i.e., a buried trench) from a tube in which a fluorine-doped zone is deposited by MCVD. The core rod is subsequently inserted inside the tube having the buried trench, and the assembly is overcladded. The document identifies an increase in OH bonds when the core is formed by MCVD from an inexpensive tube that does not present a high level of purity. The method described in that document thus seeks to limit optical losses in the core, in particular when an optical fiber having a profile with a buried trench is to be fabricated.

It is also desirable to fabricate optical fiber preforms having large capacities. The capacity of an optical fiber preform is defined as the length of optical fiber that can be drawn from that preform. The greater the diameter of the preform, the greater it capacity. To reduce fabrication costs, it is desirable to provide optical fibers of great linear length from a given optical fiber preform. It is therefore desirable to fabricate preforms of large diameter while complying with dimensional constraints relating to the diameter of the central core and the diameter of the optical cladding. After overcladding, the final preform (i.e., the optical fiber preform) must present the same ratio of core diameter to cladding diameter as is to be achieved in the optical fiber drawn therefrom.

During fabrication of the preform, it is also desirable to limit, as much as possible, the amount of glass that needs to be deposited before overcladding. This advantageously reduces the cost of fabricating the optical fiber, because glass doped by a CVD method (MCVD, FCVD, PCVD), a VAD method, or an OVD method is more expensive than the glass of the deposition tube or than the grains of natural silica used for plasma deposition while overcladding. It should also be observed that limiting the amount of glass that needs to be deposited before overcladding advantageously enables a greater length of optical fiber to be fabricated without increasing the capacity of the deposition bench. Fabricating optical fiber preforms of large capacity and/or optical fiber preforms with a smaller fraction of deposited glass thus enables productivity to be improved.

Furthermore, it is advantageous for this improvement in productivity to be obtained without substantial modification to the deposition benches currently available. Typically, a deposition bench presents limitations in terms of the maximum capacity of glass that may be deposited; this limitation is generally expressed in terms of cross-sectional area (CSA). Conventionally, the CSA of a deposited layer having circular symmetry is equal to π(Rₑₓₜ²−Rᵢₙₜ²) where Rₑₓₜ and Rᵢₙₜ are the outside and inside radii of the layer. The maximum CSA that can be deposited while fabricating a preform depends on the type of bench used. An optical fiber manufacturer may thus have deposition benches available that present different capacities, i.e., different depositable CSAs.

The fabrication of a large-diameter optical fiber preform for drawing into an optical fiber that is insensitive to bending (e.g., that satisfies the G.657 recommendations) implies forming a buried trench of great width in the primary preform to comply with scaling ratios from the preform to the drawn optical fiber.

The methods described with respect to the above-mentioned documents do not enable the production of a buried trench that is both deeply buried and thoroughly uniform so as to satisfy constraints concerning limited bending losses and sufficiently wide so as to enable a large capacity preform to be made at a cost that is competitive for FTTH or FTTC type applications.

In particular, the techniques that consist in using a fluorine-doped tube do not enable sufficient control to be obtained over the buried trench deposition to guarantee compliance with the constraints of Recommendation G.657.

Similarly, depositing a buried trench by MCVD cannot achieve a buried trench that is deep, uniform, and of great width to constitute a preform of large capacity.

Furthermore, fabricating an optical fiber preform of large capacity requires the use of a deposition bench having a large depositable CSA. Such deposition benches are uncommon and expensive.

Therefore, a need exists for a method of fabricating an optical fiber preform that enables a large capacity optical fiber preform to be made at a competitive price without substantial modification to available deposition benches.

### SUMMARY

Accordingly, in one aspect, the present invention embraces a method of manufacturing an optical fiber preform that includes (i) preparing a first rod that includes a central core from a first deposition tube and (ii) preparing a second rod that includes a buried trench from a second deposition tube. Typically, the method includes fitting the second rod as a sleeve on the first rod (i.e., sleeving the first rod with the second rod).

In an exemplary embodiment, the first rod and second rod are prepared via a chemical vapor deposition on the interior of the respective first and second tubes.

In another exemplary embodiment, the method includes fabricating an optical fiber preform that includes a central core, an intermediate cladding, a buried trench, and an outer cladding.

In yet another exemplary embodiment, the central core is formed entirely in the first rod (i.e., none of the central core is formed in the second rod).

In yet another exemplary embodiment, the second rod is prepared by plasma-assisted chemical vapor deposition.

In yet another exemplary embodiment, the first rod is prepared by modified chemical vapor deposition, furnace-assisted CVD, and/or plasma-assisted CVD.

In yet another exemplary embodiment, the method includes stretching the first rod before fitting the second rod as a sleeve.

In yet another exemplary embodiment, the method includes chemically etching at least a portion of the first tube before fitting the second rod as a sleeve.

In yet another exemplary embodiment, the method includes overcladding the outside of the second rod or fitting a sleeve thereto to reach a final preform diameter (i.e., an optical preform diameter) greater than or equal to 140 millimeters (mm).

In yet another exemplary embodiment, the method includes depositing glass on the interior of the first and second tubes to form deposited zones such that cross-sectional area of the deposited zones deposited in each of the rods is about 700 square millimeters (mm²) or less.

In yet another exemplary embodiment, the method includes depositing dopants on the interior of the second deposition tube at a concentration that achieves a buried trench having a refractive index difference of between about −4×10⁻³ and −10×10⁻³ relative to an outer cladding.

In yet another exemplary embodiment, the method includes depositing dopants on the interior of the second deposition tube to achieve a buried trench having a longitudinal variation in refractive index of less than ten percent (i.e., +/−10%) over most of the second rod's length.

In yet another exemplary embodiment, the method includes depositing dopants on the interior of the second deposition tube to achieve a buried trench having a cross-sectional area of between about 300 mm² and 700 mm².

In yet another exemplary embodiment, the method includes depositing dopants on the interior of the second deposition tube to achieve a buried trench having a longitudinal variation in cross-sectional area of less than ten percent (i.e., +/−10%) over most of the second rod's length.

In yet another exemplary embodiment, the method includes depositing dopants on the interior of the second deposition tube to achieve a buried trench having a volume of between about −2550×10⁻³ mm² and −760×10⁻³ mm².

In yet another exemplary embodiment, the method includes depositing dopants on the interior of the second deposition tube to achieve a buried trench having a longitudinal variation in volume of less than 15 percent (i.e., +/−15%) over most of the second rod's length.

In another aspect, the present invention embraces an optical fiber preform that includes a central core, an intermediate cladding, a buried trench, and an outer cladding.

In an exemplary embodiment, the optical fiber preform's central core has a refractive index difference relative to the outer cladding of between about 4×10⁻³ and 6×10⁻³.

In another exemplary embodiment, the optical fiber preform's central core has a refractive index difference relative to the intermediate cladding of between about 4×10⁻³ and 6×10⁻³.

In yet another exemplary embodiment, the optical fiber preform's buried trench has a refractive index relative to the outer cladding of between about −4×10⁻³ and −10×10⁻³.

In yet another exemplary embodiment, the optical fiber preform's buried trench has a longitudinal variation in refractive index of less than ten percent (i.e., +/−10%) over most of the optical fiber preform's length.

In yet another exemplary embodiment, the optical fiber preform has an outer diameter of about 140 millimeters or greater.

In yet another exemplary embodiment, the optical fiber preform's buried trench has a cross-sectional area of between about 300 mm² and 700 mm².

In yet another exemplary embodiment, the optical fiber preform's buried trench has a longitudinal variation in cross-sectional area of less than ten percent (i.e., +/−10%) over most of the optical fiber preform's length.

In yet another exemplary embodiment, the optical fiber preform's buried trench has a volume of between about −2550×10⁻³ mm² and −760×10⁻³ mm².

In yet another exemplary embodiment, the optical fiber preform's buried trench has a longitudinal variation in volume of less than 15 percent (i.e., +/−15%) over most of the optical fiber preform's length.

In yet another aspect, the present invention embraces a glassmaker's tube that includes a buried trench and an outer cladding.

In an exemplary embodiment, the buried trench of the glassmaker's tube has a refractive index relative to the outer cladding of between about −4×10⁻³ and −10×10⁻³.

In another exemplary embodiment, the buried trench of the glassmaker's tube has a longitudinal variation in refractive index of less than ten percent (i.e., +/−10%) over most of the length of the glassmaker's tube.

In yet another exemplary embodiment, the glassmaker's tube has an inner diameter of between about 16 millimeters and 35 millimeters.

In yet another exemplary embodiment, the buried trench of the glassmaker's tube has a cross-sectional area of between about 300 mm² and 700 mm².

In yet another exemplary embodiment, the buried trench of the glassmaker's tube has a longitudinal variation in cross-sectional area of less than ten percent (i.e., +/−10%) over most of the length of the glassmaker's tube.

In yet another exemplary embodiment, the buried trench of the glassmaker's tube has a volume of between about −2550×10⁻³ mm² and −760×10⁻³ mm².

In yet another exemplary embodiment, the buried trench of the glassmaker's tube has a longitudinal variation in volume of less than 15 percent (i.e., +/−15%) over most of the length of the glassmaker's tube.

In yet another aspect, the present invention embraces a method of manufacturing an optical fiber that includes (i) preparing a first rod that includes a central core from a first deposition tube, (ii) preparing a second rod that includes a buried trench from a second deposition tube, (iii) fitting the second rod as a sleeve on the first rod (i.e., sleeving the first rod with the second rod) to achieve a primary preform, (iv) overcladding or sleeving the primary preform to achieve an optical fiber preform, and (iv) drawing an optical fiber from the optical fiber preform in a fiber-drawing tower.

In an exemplary embodiment, the method includes preparing the first and second rods via chemical vapor deposition on the interior of the first and second deposition tubes.

In yet another aspect, the present invention embraces a method of manufacturing an optical fiber that includes manufacturing a primary preform via chemical vapor deposition on the interior of a glassmaker's tube that includes an outer cladding and a buried trench, overcladding or sleeving the primary preform to achieve an optical fiber preform, and drawing an optical fiber from the optical fiber preform in a fiber-drawing tower.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 graphically depicts the set refractive index profile of an exemplary optical fiber according to the present invention.

FIG. 2 schematically depicts the first and second rods prepared according to an exemplary embodiment of the present invention.

FIG. 3 schematically depicts a cross-sectional view of an optical fiber preform manufactured in accordance with an exemplary embodiment of the method of the present invention.

### DETAILED DESCRIPTION

The present invention embraces a method of fabricating an optical fiber preform that enables a large capacity optical fiber preform to be made at a competitive price without substantial modification to available deposition benches. Typically, the optical fiber preforms fabricated by the method of the present invention may be used to achieve optical fibers that comply with the ITU-T G.652 and G.657 recommendations.

The present invention also embraces an optical fiber preform that includes a central core, an intermediate cladding, a buried trench, and an outer cladding. Typically, the term “buried trench” is used to describe a radial portion of an optical fiber preform or optical fiber that has a refractive index that is substantially less than the refractive index of the outer cladding.

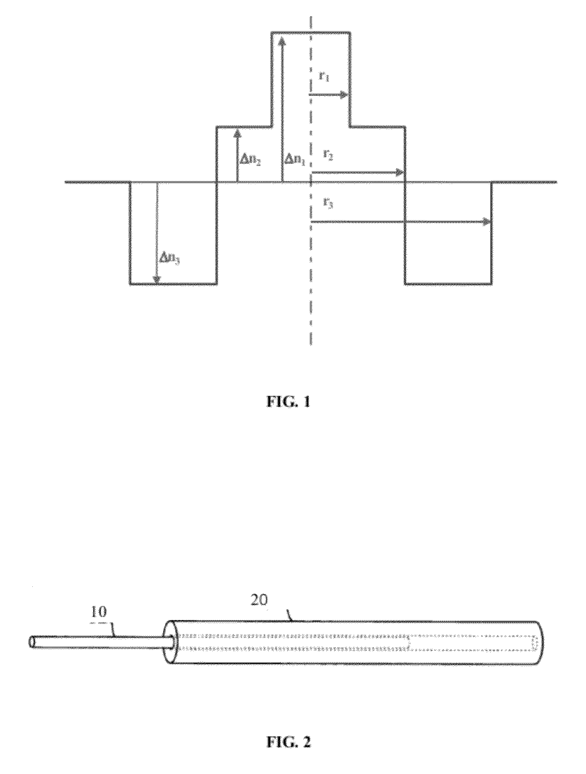

FIG. 1 graphically depicts the set refractive index profile of an exemplary optical fiber according to the present invention. The refractive index profile is generally classified according to the graphical appearance of the function that associates the refractive index with the radius of the optical fiber. Conventionally, the distance r to the center of the optical fiber is shown on the x-axis, and the difference between the refractive index (at radius r) and the refractive index of the optical fiber's outer cladding (e.g., an outer optical cladding) is shown on the y-axis. The depicted profile is a set profile that is representative of the optical fiber's theoretical profile. Constraints in the manufacture of the optical fiber preform and the optical fiber, however, may result in a slightly different actual profile.

Those having ordinary skill in the art will recognize that the refractive indices of an optical fiber are equivalent to those of the optical fiber preform from which the optical fiber is drawn. Furthermore, the radii of the core and cladding layers within an optical fiber are determined by the radii of the core and cladding layers within the optical fiber preform from which the optical fiber is drawn. Thus, reference to an optical fiber's refractive index profile can be readily extrapolated to the corresponding optical fiber preform. That said, those having ordinary skill in the art will appreciate that the drawing process might cause an optical fiber's refractive index to deviate slightly from its corresponding optical fiber preform.

The optical fiber includes a central core having a refractive index difference Δn relative to an outer cladding. Typically, the outer cladding functions as an optical cladding. The intermediate cladding has a refractive index difference Δn₂ relative to an outer cladding. The buried trench has a refractive index difference Δn₃ relative to an outer cladding.

FIG. 1 depicts a central core having a step refractive index profile. Thus, the central core's refractive index difference is constant and equal to the central core's maximum refractive index difference Δn₁. That said, the central core may also have a trapezoidal, triangular, or alpha profile (i.e., a refractive index profile that varies as a function of radial position).

Furthermore, FIG. 1 depicts inner cladding layers (i.e., the intermediate cladding and the buried trench), each having a constant refractive index difference with respect to the outer cladding. Exemplary optical fibers according to the invention, however, may have one or more refractive index differences that vary as a function of radial position (e.g., a trapezoidal, triangular, or alpha profile). For inner cladding layers having non-constant refractive indices, the respective refractive index differences (e.g., the buried trench's refractive index difference Δn₃) refer to the largest refractive index difference between an inner cladding layer and the outer cladding layer in terms of absolute value.

As depicted, the central core has an outer radius r₁. The inner cladding has an outer radius r₂, and the buried trench has an outer radius r₃. The width of the inner cladding is defined by its inner and outer radii (i.e., r₁ and r₂ as depicted). Similarly, the width of the buried trench is defined by its inner and outer radii (i.e., r₂ and r₃ as depicted).

As noted, an optical fiber's refractive index difference at a given radius is usually measured relative to the refractive index of the outer cladding. The refractive index values of the central core, intermediate cladding, and buried trench are then presented as refractive index differences Δn_{1,2,3}. For reasons of cost, the outer cladding is typically made of natural silica, but it may also be made of doped silica to increase or decrease its refractive index (e.g., to modify the propagation of optical signals).

Those of ordinary skill in the art will recognize that the outer cladding typically has a constant refractive index. That said, if the outer cladding has a non-constant refractive index, refractive index differences are typically measured with respect to the innermost portion of the outer cladding (i.e., that portion of the outer cladding that is closest to the central core and that may affect the propagation of optical signals within the optical fiber).

Typically, the optical fiber preforms fabricated by the method of the present invention may be used to achieve optical fibers that comply with the ITU-T G.652 and G.657 recommendations. Accordingly, in exemplary embodiments, the optical fiber includes: (i) a central core having a refractive index difference Δn₁ relative to an outer cladding of between about 4×10⁻³ and 6×10⁻³ (e.g., 5×10⁻³); (ii) an intermediate cladding having a refractive index difference Δn₂ relative to an outer cladding of between about −1×10⁻³ and 1×10⁻³; and (iii) a buried trench having a refractive index difference Δn₃ relative to an outer cladding of between about −4×10⁻³ and −10×10⁻³.

Typically, the difference between the central core's refractive index difference Δn₁ and the intermediate cladding's refractive index difference Δn₂ (i.e., Δn₁-Δn₂) is between about 4×10⁻³ and 6×10⁻³.

Furthermore, the exemplary optical fiber (i.e., as drawn from an optical fiber preform) typically includes: (i) a central core having an outer radius r₁ of between about 3.5 microns and 4.5 microns; (ii) an intermediate cladding having an outer radius r₂ of between about 7.5 microns and 14.5 microns; (iii) and a buried trench having an outer radius r₃ of between about 13 microns and 18 microns.

Exemplary optical fibers include a central core having a surface integral V₀₁ of between about 17×10⁻³ microns and 24×10⁻³ microns, where V₀₁ is defined by the following equation:

$${V}_{01} = {\int }_{0}^{{r}_{1}} Δ n ( r ) \cdot d r \approx {r}_{1} \times Δ {n}_{1}$$

wherein Δn(r) is the central core's refractive index difference as a function of radial position.

Exemplary optical fibers may also include a buried trench having a surface integral V₀₃ of between about −55×10⁻³ microns and −25×10⁻³ microns, where V₀₃ is defined by the following equation:

$${V}_{03} = {\int }_{{r}_{2}}^{{r}_{3}} Δ n ( r ) \cdot d r \approx ( {r}_{3} - {r}_{2} ) \times Δ {n}_{3}$$

wherein Δn(r) is the buried trench's refractive index difference as a function of radial position.

Exemplary optical fibers may also include a buried trench having a volume integral V₁₃ of between about −1200×10⁻³ μm² and −600×10⁻³ μm², where V₁₃ is defined by the following equation:

$${V}_{13} = 2 \cdot {\int }_{{r}_{2}}^{{r}_{3}} Δ n ( r ) \cdot r d r \approx ( {r}_{3}^{2} - {r}_{2}^{2} ) \times Δ {n}_{3}$$

wherein Δn(r) is the buried trench's refractive index difference as a function of radial position.

Exemplary optical fibers possess (i) at a wavelength of 1310 nanometers, a nominal mode field diameter of between 8.6 microns and 9.5 microns, (ii) a zero chromatic dispersion wavelength of between about 1300 nanometers and 1324 nanometers, (iii) an in-cable cut-off wavelength of less than 1260 nanometers, and (iv) bending losses satisfying the criteria of the G.657 recommendations as set out in Table I.

As noted, the present invention embraces a method of fabricating a large-capacity optical fiber preform that may be used to manufacture an optical fiber that complies with the ITU-T G.652.D and G.657 recommendations. The fabrication method according to the invention proposes separately preparing (i) the central core together with at least a portion of the intermediate cladding, and (ii) the buried trench together with at least a portion of the outer cladding.

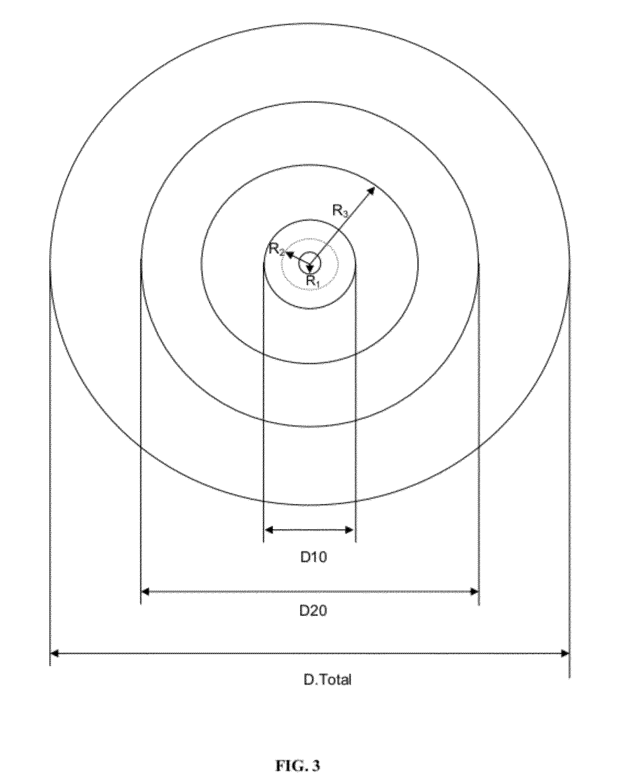

As depicted in FIG. 2, a first rod 10 is prepared. The first rod 10 includes at least the central core (Δn₁, r₁) and, in some exemplary embodiments, a portion of the intermediate cladding (Δn₂, r₂). The intermediate cladding (Δn₂, r₂) may also be contained completely within the first rod 10.

The first rod 10 is typically prepared by chemical vapor deposition (CVD) in a first deposition tube of pure or doped silica. For example, the first rod 10 may be prepared using modified chemical vapor deposition (MCVD), furnace-assisted CVD (FCVD), and/or plasma-assisted CVD (PCVD).

FIG. 2 also depicts a second rod 20 that is also prepared by chemical vapor deposition (CVD) (e.g., via a PCVD-type deposition). The second rod 20 is made from a second deposition tube, of pure or doped silica, in which CVD deposits are made to form at least the buried trench (Δn₃, r₃) and, in some exemplary embodiments, a portion of the intermediate cladding (Δn₂, r₂). The starting tube (i.e., the second deposition tube) for the second rod 20 may form a portion of the outer cladding or a portion of a second intermediate cladding.

PCVD-type depositions make it possible to form a buried trench in the second rod 20 that is very deep (i.e., the buried trench's refractive index difference Δn₃ is substantially less than that of the outer cladding) and of great width while ensuring good control over the uniformity of doping within the trench.

The buried trench deposited in the second rod 20 typically has (i) a refractive index difference Δn₃ relative to the outer cladding of between about −4×10⁻³ and −10×10⁻³ and (ii) a longitudinal variation in refractive index of less than ten percent (i.e., +/−10%) over substantially the entire length of the second rod (e.g., about 70 percent or more, such as about 75-95 percent). More specifically, over substantially the entire length of the second rod, the refractive-index variation does not exceed the mean refractive index by more than 10 percent anywhere within the deposited, buried trench.

The buried trench deposited in the second rod 20 typically has (i) a cross-sectional area of between about 300 mm² and 700 mm² and (ii) a longitudinal variation in cross-sectional area of less than ten percent (i.e., +/−10%) over substantially the entire length of the second rod (e.g., about 70 percent or more, such as about 75-95 percent).

In some exemplary embodiments, the buried trench's volume may be described by the product of the buried trench's cross-sectional area multiplied by the buried trench's refractive index difference Δn₃ divided by the number pi (i.e., (CSA×Δn₃)+π). In this regard, the buried trench's volume may be between about −2550×10⁻³ mm² and −760×10⁻³ mm² and have a longitudinal variation of less than 15 percent (i.e., +/−15%) over substantially the entire length of the second rod (e.g., about 70 percent or more, such as about 80-90 percent).

A preform typically has a length of between about 700 millimeters and 1500 millimeters (e.g., about one meter). The deposition of the buried trench is controlled to achieve a refractive index and cross-sectional area that exhibit relatively low longitudinal variation over substantially the entire length of the preform (e.g., ˜70%, ˜75%, ˜80%, ˜85%, ˜90%, or ˜95% or more of the preform's length).

During the method of the present invention, deposition in the second deposition is stopped after (i) the buried trench has been formed or (ii) the buried trench and a portion of the intermediate cladding has been formed. In other words, typically none of the central core is deposited in the second deposition tube.

As shown in FIG. 2, the second rod 20 is hollow; it can therefore be fitted on the first rod 10 as a sleeve. Where necessary, the first rod 10 may be stretched before the second rod is fitted thereon as a sleeve to reduce its CSA and comply with scaling constraints for the desired fiber profile. In another embodiment, the size of the first rod 10 may be reduced prior to the second rod 20 being fitted as a sleeve thereon by using a chemical etching method. Such a chemical etching method serves not only to reduce the CSA of the first rod 10 but may also limit the contribution of the first deposition tube to optical losses. The purity of a deposition tube is generally not as good as that of the glass that is deposited by the CVD method. The first tube, constituting all or part of the intermediate cladding, is thus a possible source of degraded optical losses if it is (i) not far enough away from the optical fiber's central core and/or (ii) not sufficiently pure.

The second rod 20 fitted as a sleeve on the first rod 10, where appropriate after stretching and/or chemically etching the first rod as described above, constitutes a primary preform that can be overcladded to reach the total diameter needed to conserve the scaling ratios with the intended optical fiber profile. Depending on the implementation, overcladding may be performed on the second rod 20 before or after it is fitted as a sleeve on the first rod 10. Overcladding may be performed by depositing pure or doped silica grains on the outside of the primary preform or by fitting a tube as a sleeve on the primary preform. With a preform of large size, building out (i.e., overcladding or sleeving) is preferably performed with grains of silica.

FIG. 3 schematically depicts a cross-sectional view of an optical fiber preform manufactured in accordance with an exemplary embodiment of the method according to the present invention. The optical fiber preform's central core has a radius R. As depicted, the intermediate cladding includes (i) a deposited portion having a radius R₂ and (ii) the first deposition tube of the first rod having an outer diameter D10. The first rod's outer diameter D10 may be reduced by chemical etching (i.e., chemical etching of a portion of the first deposition tube) before it is inserted in the second rod. In exemplary embodiments, the first deposition tube of the first rod 10 may be removed completely by chemical etching (e.g., as described below with reference to certain examples). The buried trench has an outer radius R₃ and is deposited in a second deposition tube to form a second rod 20 having an outer diameter D20. The assembly (i.e., the primary preform) of the second rod 20 fitted as a sleeve on the first rod 10 is overcladded to reach a total diameter D.Total.

The method according to the present invention achieves large capacity preforms without modifying the performance of deposition benches. The number of the layers deposited by CVD in each of the rods 10 and 20 is limited thereby controlling cost.

In an exemplary embodiment, only the layers corresponding to the central core and possibly to a portion of the intermediate cladding are deposited in the first rod 10, and only the layers corresponding to the buried trench and possibly to a portion of the intermediate cladding are deposited in the second rod 20. That is, the entire central core is deposited in the first rod 10 (and none of the central core is deposited in the second rod 20). The deposition of the central core entirely in the first rod 10 reduces the risk of core contamination. For example, deposition of the central core entirely in the first rod 10 averts the eventual formation of a core-to-core interface, which would otherwise be created when sleeving the first rod 10 with the second rod 20. Preserving the integrity of the central core in this way is important (especially for single-mode fibers that comply with the ITU-T G.652.D attributes) as most of the optical power propagates within the central core.

In an exemplary embodiment, almost all (e.g., between about 90 and 95 percent) or all (i.e., 100 percent) of the intermediate cladding is present in first rod 10. Medium size deposition benches can therefore be used to form each of the rods 10 and 20. In particular, the CSAs of the zones deposited in each of the rods 10, 20 are typically less than about 700 mm² for an optical fiber preform (i.e., a final preform) having an outer diameter of about 140 millimeters or greater.

In exemplary embodiments, the method according to the invention limits the CSA proportions of the zones obtained by deposition, in the first rod 10 and in the second rod 20, relative to the size of the preform. In this regard, the presence of the first deposition tube of the first rod 10 replaces a portion of the deposited glass. Specifically, as compared to conventional fabrication techniques for a given profile, it has been found that, using exemplary methods of the present invention, it is possible to obtain a reduction of 5 percent or more in the ratio of (i) the CSA of all of the deposited zones (ignoring the overcladding) to (ii) the total CSA of the optical fiber preform. The cost of fabricating a large optical fiber preform is thus limited and investment in deposition bench equipment is not essential.

The optical fiber preform fabricated by exemplary methods according to the invention may be drawn to produce an optical fiber that satisfies the criteria of Recommendations G.652, G.657.A2, G.657.B2, and G.657.B3. To this end, the scaling ratios between the optical fiber preform and the drawn optical fiber require optical fiber preform dimensions such that the buried trench has an outer radius r₃ of between about 13 microns and 18 microns for an optical fiber having an outer diameter of 125 microns. Specifically, the ratio between the buried trench's outer radius R₃ and the optical fiber preform's outer radius (i.e., one half of D.Total) is typically between about 0.208 and 0.288.

Chemical vapor deposition (CVD), and in particular PCVD-type deposition of the buried trench makes it possible to achieve a deeply buried trench (i.e., Δn₃ of between about −4×10⁻³ and −10×10⁻³) and a very large buried trench (e.g., a buried trench having a CSA of between about 300 mm² and 700 mm²), while ensuring appropriate scaling of the buried trench to avoid optical-fiber performance degradation. Specifically, over substantially the entire length of the optical fiber preform (e.g., about 70 percent or more, such as about 75-95 percent), the buried trench has (i) a longitudinal variation in refractive index of less than ten percent and (ii) longitudinal variation in CSA of less than ten percent. In some exemplary embodiments, buried trench has a volume of between about −2550×10⁻³ mm² and −760×10⁻³ mm² that exhibits a longitudinal variation of less than 15 percent over substantially the entire length of the optical fiber preform (e.g., about 70 percent or more, such as 85 percent or so).

Tables III, IV and V (below) provide characteristics of optical fiber preforms made by exemplary methods according to the present invention (i.e., exemplary optical fiber preforms) as well as comparative optical fiber preforms made by conventional methods.

In embodiments that include a buried trench having a refractive index difference Δn₃ of −7×10⁻³, exemplary optical fiber preforms 1-1, 1-2, and 2 may be drawn into optical fibers that satisfy the criteria of Recommendations G.652, G.657.A2, and G.675.B2. In embodiments that include a buried trench having a refractive index difference Δn₃ of −10×10⁻³, exemplary optical fiber preforms 1-1, 1-2, and 2 may be drawn into optical fibers that satisfy the criteria of Recommendation G.657.B3

In embodiments that include a buried trench having a refractive index difference Δn₃ of −5×10⁻³, exemplary optical fiber preforms 3-1, 3-2, and 3-3 may be drawn into optical fibers that satisfy the criteria of Recommendations G.652, G.657.A2, and G.675.B2. In embodiments that include a buried trench having a refractive index difference Δn₃ of −7×10⁻³, exemplary optical fiber preforms 3-1, 3-2, and 3-3 may be drawn into optical fibers that satisfy the criteria of Recommendation G.675.B3.

Comparative optical fiber preforms 1A and 3A represent optical fiber preforms fabricated using conventional methods on deposition benches having relatively small capacities corresponding to a deposited CSA of about 340 mm². Comparative optical fiber preform 2A represents an optical fiber preform fabricated using a conventional method on a deposition bench having a relatively large capacity corresponding to a deposited CSA of about 550 mm².

Comparative optical fiber preforms 1B, 2B, and 3B represent extrapolations of optical fiber preforms fabricated using conventional methods on deposition benches having very large capacities corresponding to a deposited CSA of about 800 mm², 1300 mm², and 1100 mm², respectively. Comparative examples 1B, 2B, and 3B are prophetic and represent what should be achievable on benches having very large capacities. Comparative examples 1B, 2B, and 3B were devised by scaling-up from examples 1A, 2A, and 3A.

Examples 1-1 and 1-2 demonstrate that it is possible to achieve the same capacity as prophetic, comparative example 1B while using deposition benches of smaller capacity. The same applies for (i) example 2 of the invention compared with prophetic, comparative example 2B and (ii) examples 3-1, 3-2, and 3-3 of the invention relative to prophetic, comparative example 3B.

The set refractive index profiles of examples 1-1 and 1-2 are identical. The structural difference between these two examples is the composition of the intermediate cladding of the primary preform. In example 1-1, the intermediate cladding includes (i) a deposited portion having a CSA equal to 145.9 mm², and (ii) a portion constituted by the first deposition tube of the first rod having a CSA equal to 180.6 mm² (see Table IV). In example 1-2, the intermediate cladding includes (i) a deposited portion having a CSA equal to 281.7 mm², and (ii) a portion constituted by the first deposition tube of the first rod having a CSA equal to 44.8 mm² (see Table IV).

The smaller proportion of the deposition tube of example 1-2 compared with example 1-1 typically results in better attenuation performance in the optical fiber drawn from the corresponding preform. In practice, the same size first deposition tube may be used for the first rod (i.e., a first deposition tube having a CSA equal to 180.6 mm²) in each of the examples 1-1 and 1-2. Chemical etching is applied to the first rod in example 1-2 to reduce the CSA of the first deposition tube.

Similarly, the set refractive index profiles of examples 3-1, 3-2, and 3-3 are identical. In example 3-1, the first deposition tube of the first rod is removed completely by a chemical etching method. In example 3-3, the intermediate cladding is constituted exclusively by the first deposition tube of the first rod. Example 3-2 represents an intermediate configuration between examples 3-1 and 3-3. Thus, in example 3-2, only part of the first deposition tube of the first rod is removed by chemical etching, and the intermediate cladding includes the remaining portion of the first deposition tube. In practice, the purity of example 3-3's first deposition tube should be close to that of glass deposited by CVD if it is desired to conserve attenuation that is compatible with Recommendation G.652.

In Table III, the values “2Rₙ” designate respectively the outer diameters of the central core 2R₁, the deposited portion of the intermediate cladding 2R₂, and the buried trench 2R₃. The value “D10” designates the outer diameter of the first rod of the optical fiber preform, and the value “D20” designates the outer diameter of the second rod of the optical fiber preform. The value “D.Total” designates the total diameter of the overcladded optical fiber preform (i.e., the final preform).

TABLE III

| | First rod 10 | | | | Second rod 20 | | Over-cladding |
|---|---|---|---|---|---|---|---|
| | 2R₁ | 2R₂ | 2R₃ | D10 | 2R₃ | D20 | D.Total |
| Unit | mm | mm | mm | mm | mm | mm | mm |
| Comp. | 6.07 | 14.63 | 20.81 | 25.97 | — | — | 98.5 |
| ex. 1A | | | | | | | |
| Comp. | 9.3 | 22.41 | 31.88 | 39.79 | — | — | 150.9 |
| ex. 1B | | | | | | | |
| Ex. 1-1 | 9.3 | 16.5 | — | 22.41 | 31.88 | 37.2 | 150.9 |
| Ex. 1-2 | 9.3 | 21.1 | — | 22.41 | 31.88 | 37.2 | 150.9 |
| Comp. | 7.63 | 18.39 | 26.5 | 32.64 | — | — | 123.8 |
| ex. 2A | | | | | | | |
| Comp. | 11.69 | 28.18 | 40.61 | 50.01 | — | — | 189.7 |
| ex. 2B | | | | | | | |
| Ex. 2 | 11.69 | 20.74 | — | 28.17 | 40.61 | 46.75 | 189.7 |
| Comp. | 5.5 | 12.98 | 20.83 | 25.97 | — | — | 87.9 |
| ex. 3A | | | | | | | |
| Comp. | 9.89 | 23.33 | 37.44 | 46.68 | — | — | 158 |
| ex. 3B | | | | | | | |
| Ex. 3-1 | 9.89 | 23.33 | — | 23.33 | 37.44 | 42.05 | 158 |
| Ex. 3-2 | 9.89 | 17.51 | — | 23.33 | 37.44 | 42.05 | 158 |
| Ex. 3-3 | 9.89 | — | — | 23.33 | 37.44 | 42.05 | 158 |

As indicated in Table III, the buried trench of the comparative examples is deposited in the first rod, whereas the buried trench of the examples according to the present invention is deposited in the second rod. Table III also shows that the outer diameter of the intermediate cladding is equal to 2R₂ in the comparative examples, whereas the outer diameter of the intermediate cladding is equal to D10 in the examples according to the present invention. As depicted in FIG. 3, the intermediate cladding includes (i) a deposited portion having a radius R₂ and (ii) a portion of the first deposition tube of the first rod having an outer diameter D10.

In Table IV, the values “CSA,” designate respectively the cross-sectional areas of the central core CSA₁, the deposited intermediate trench CSA₂, and of the buried trench CSA₃. The values “CSA_{T10}” and “CSA_{T20}” designate respectively the cross-sectional areas of the deposition tubes used to form the first and second rods. The values “CSA10” and “CSA20” designate respectively the cross-sectional areas of the first and second rods of the preform.

It should be noted that, for exemplary embodiments of the optical fiber preform according to the invention, the interior diameter of the buried trench is D10 (i.e., the outer diameter of the first rod). In these exemplary embodiments, the second rod does not include a portion of the intermediate cladding. In contrast, the buried trench's interior diameter for the comparative examples is 2R₂ (i.e., the outer diameter of the intermediate cladding). Thus, for the exemplary optical fiber preforms according to the invention, CSA₃ may be calculated using the following formulas:

CSA₃=π×((2R₃)²−D10²)/4; or

CSA₃=π×(R₃²−D10²/4).

The CSA₃ of the comparative examples may be calculated using the following formulas:

CSA₃=π×((2R₃)²(2R₂)²)/4; or

CSA₃=π×(R₃²−R₂²).

TABLE IV

| | First rod 10 | | | | | Second rod 20 | | |
|---|---|---|---|---|---|---|---|---|
| | CSA₁ | CSA₂ | CSA₃ | CSA_{T10} | CSA10 | CSA₃ | CSA_{T20} | CSA20 |
| Unit | mm² | mm² | mm² | mm² | mm² | mm² | mm² | mm² |
| Comp. | 28.94 | 139.2 | 172 | 189.6 | 529.7 | — | — | — |
| ex. 1A | | | | | | | | |
| Comp. | 67.93 | 326.5 | 403.8 | 445.2 | 1243.4 | — | — | — |
| ex. 1B | | | | | | | | |
| Ex. 1-1 | 67.93 | 145.9 | — | 180.6 | 394.4 | 403.8 | 288.6 | 692.4 |
| Ex. 1-2 | 67.93 | 281.7 | — | 44.8 | 394.4 | 403.8 | 288.6 | 692.4 |
| Comp. | 45.72 | 219.9 | 285.9 | 285.2 | 836.7 | — | — | — |
| ex. 2A | | | | | | | | |
| Comp. | 107.33 | 516.4 | 671.6 | 669 | 1964.3 | — | — | — |
| ex. 2B | | | | | | | | |
| Ex. 2 | 107.33 | 230.5 | — | 285.4 | 623.2 | 672 | 421.3 | 1093.3 |
| Comp. | 23.76 | 108.6 | 208.5 | 188.9 | 529.8 | — | — | — |
| ex. 3A | | | | | | | | |
| Comp. | 76.82 | 350.7 | 673.5 | 610.5 | 1711.5 | — | — | — |
| ex. 3B | | | | | | | | |
| Ex. 3-1 | 76.82 | 350.7 | — | — | 427.5 | 673.5 | 287.8 | 961.3 |
| Ex. 3-2 | 76.82 | 163.9 | — | 186.8 | 427.5 | 673.5 | 287.8 | 961.3 |
| Ex. 3-3 | 76.82 | — | — | 350.7 | 427.5 | 673.5 | 287.8 | 961.3 |

As noted, comparative examples 1B, 2B, and 3B are prophetic examples of optical fiber preforms that should be achievable on benches having very large capacities. In particular, example 1B is an optical fiber preform that would require a deposition bench having a depositable CSA of 800 mm² (CSA₁+CSA₂+CSA₃=798.23 mm²). Example 2B is an optical fiber preform that would require a deposition bench having a depositable CSA of about 1300 mm², and example 3B is an optical fiber preform that would require a deposition bench having a depositable CSA of about 1100 mm².

Table IV demonstrates that, although the optical fiber preforms according to the invention have a large capacity, they may be fabricated on deposition benches having depositable CSAs that are much smaller than for comparative examples 1B, 2B, and 3B. In particular, example 1-1 requires (i) a deposition bench having a depositable CSA of about 220 mm² (CSA₁+CSA₂=213.83 mm²) for the first rod and (ii) a deposition bench having a depositable CSA of about 400 mm² (CSA₃=403.8 mm²) for the second rod. Example 1-2 requires (i) a deposition bench having a depositable CSA of about 350 mm² (CSA₁+CSA₂=349.63 mm²) for the first rod and (ii) a deposition bench having a depositable CSA of about 400 mm² (CSA₃=403.8 mm²) for the second rod. Thus, in comparison with example 1B, the method according to the invention can be used to fabricate optical fiber preforms similar to examples 1-1 and 1-2 having a total diameter D.Total of about 150 millimeters while using deposition benches of small and medium capacity.

Similarly, example 2 requires (i) a deposition bench having a depositable CSA of about 340 mm² (CSA₁+CSA₂=337.83 mm²) for the first rod and (ii) a deposition bench having a depositable CSA of about 670 mm² (CSA₃=672 mm²) for the second rod. Thus, in comparison with example 2B, the method according to the invention can be used to fabricate optical fiber preforms similar to example 2 having a total diameter D.Total of about 190 millimeters, while using deposition benches of medium capacity.

Example 3-1 requires (i) a deposition bench having a depositable CSA of about 430 mm² for the first rod and (ii) a deposition bench having a depositable CSA of about 670 mm² for the second rod. Example 3-2 requires (i) a deposition bench having a depositable CSA of about 240 mm² for the first rod and (ii) a deposition bench having a depositable CSA of about 670 mm² for the second rod. Example 3-3 requires (i) a deposition bench having a depositable CSA of about 80 mm² for the first rod and (ii) a deposition bench having a depositable CSA of about 670 mm² for the second rod. Thus, in comparison with example 3B, the method according to the invention can be used to fabricate optical fiber preforms similar to examples 3-1, 3-2, and 3-3 having a total diameter D.Total of about 158 millimeters, while using deposition benches of small and medium capacity.

In Table V, the value “CSA Deposits” designates the cross sectional area of the zones obtained by deposition (i.e., the sum of CSA₁, CSA₂, and CSA₃). The value “CSA Tube” designates the cross-sectional area of the zones occupied by the deposition tubes used for making the preform (i.e., the sum of CSA_{T10} and CSA_{T20}). The value “CSA Overcladding” designates the cross-sectional area of the zone obtained by overcladding the second rod to obtain the final preform ready for drawing (i.e., the optical fiber preform). The value “CSA Total” designates the cross-sectional area of the built-out preform (i.e., the optical fiber preform). Table V also gives the ratios of these values for each example compared with the comparative examples.

TABLE V

| | | | CSA | | CSA |
|---|---|---|---|---|---|
| | CSA | CSA | Over- | CSA | Deposits/ |
| | Deposits | Tube | cladding | Total | CSA Total |
| | Unit | | | | |
| | mm² | mm² | mm² | mm² | — |
| Comp. ex. 1A | 340.1 | 189.6 | 7090 | 7620 | 4.46% |
| Comp. ex. 1B | 798.2 | 445.2 | 16641 | 17884 | 4.46% |
| Ex. 1-1 | 617.6 | 469.2 | 16797 | 17884 | 3.45% |
| Ratio | 1.82 | 2.47 | 2.37 | 2.35 | 0.77 |
| Ex. 1-1/ | | | | | |
| Comp. ex. 1A | | | | | |
| Ex. 1-2 | 753.4 | 333.4 | 16797 | 17884 | 4.21% |
| Ratio | 2.22 | 1.76 | 2.37 | 2.35 | 0.94 |
| Ex. 1-2/ | | | | | |
| Comp. ex. 1A | | | | | |
| Comp. ex. 2A | 551.5 | 285.2 | 11201 | 12038 | 4.58% |
| Comp. ex. 2B | 1295.3 | 669 | 26299 | 28263 | 4.58% |
| Ex. 2 | 1009.8 | 706.7 | 26547 | 28264 | 3.57% |
| Ratio Ex. 2/ | 1.83 | 2.48 | 2.37 | 2.35 | 0.78 |
| Comp. ex. 2A | | | | | |
| Comp. ex. 3A | 340.9 | 350.7 | 5377 | 6069 | 5.62% |
| Comp. ex. 3B | 1101 | 610.5 | 17895 | 19607 | 5.62% |
| Ex. 3-1 | 1101 | 287.8 | 18218 | 19607 | 5.62% |
| Ratio | 3.23 | 0.82 | 3.39 | 3.23 | 1.00 |
| Ex. 3-1/ | | | | | |
| Comp. ex. 3A | | | | | |
| Ex. 3-2 | 914.2 | 474.6 | 18218 | 19607 | 4.66% |
| Ratio | 2.68 | 1.35 | 3.39 | 3.23 | 0.83 |
| Ex. 3-2/ | | | | | |
| Comp. ex. 3A | | | | | |
| Ex. 3-3 | 750.3 | 638.5 | 18218 | 19607 | 3.83% |
| Ratio | 2.20 | 1.82 | 3.39 | 3.23 | 0.68 |
| Ex. 3-3/ | | | | | |
| Comp. ex. 3A | | | | | |

Exemplary embodiments of the method according to the invention make it possible to achieve preforms having buried trenches of very large sizes. In particular, the CSA of the buried trench CSA₃ is typically between about 300 mm² and 700 mm². In addition, exemplary embodiments of the method according to the invention make it possible to fabricate large-capacity preforms while using deposition benches of small and/or medium capacity. In particular, for some exemplary embodiments, the CSAs of the zones deposited in each of the rods (i.e., CSA₁+CSA₂ in the first rod 10, and CSA₃ in the second rod 20) is less than 700 mm², even though the final preform is of large size with an outer diameter of about 140 millimeters or greater.

Thus, the productivity of optical fiber fabrication drawn from an optical fiber preform fabricated by the method according to the invention is improved. In example 1-1, productivity is increased by 29 percent relative to comparative example 1A. The optical fiber preform of example 1-1 requires 1.82 times as much deposition as the optical fiber preform of comparative example 1A, but has a capacity that is 2.35 times greater. For a given deposition quantity, it is therefore possible to draw 29 percent more fiber from the optical fiber preform of example 1-1 than from the comparative optical fiber preforms 1A and 1B. Using the same analysis, example 1-2 exhibits an increase in productivity of 6 percent over comparative examples 1A and 1B. Similarly, example 2 exhibits an increase in productivity of 28 percent over comparative examples 2A and 2B.

In example 3-1, in which the first deposition tube of the first rod is completely removed by chemical etching, there is no increase in productivity because the proportion of deposit is the same as in the comparative examples. Nevertheless, it is possible to fabricate the preform much more quickly because the first and second rods are fabricated separately. With examples 3-2 and 3-3, the productivity increases are, respectively, 20 percent and 47 percent compared with examples 3A and 3B.

The method according to the invention thus makes it possible to make an optical fiber preform of very large capacity without requiring significant modification to equipment. In addition, the first and second rods may be fabricated in parallel, thereby increasing the fabrication yield of the optical fiber preform.

The optical fiber preform fabricated in accordance with the present method enables a greater length of fiber to be drawn that is particularly well adapted to use in optical fiber systems installed with customers, of the FTTH or FTTC type, in which the optical fiber is subjected to severe bending constraints (e.g., because of the miniaturization of the optical units or fastening by stapling).

In particular, the optical fiber drawn from an exemplary optical fiber preform satisfies the criteria of Recommendation G.652 in terms of chromatic dispersion, mode diameter, and cut-off wavelength. The optical fiber drawn from an exemplary optical fiber preform also satisfies the criteria of Recommendation G.657 in terms of bending losses.

Exemplary embodiments of the method according to the invention also make it possible to fabricate tubes of large capacity and of very good quality. Specifically, exemplary methods include fabricating a glassmaker's tube that includes an outer cladding surrounding a buried trench. The buried trench has a refractive index relative to the outer cladding of between about −4×10⁻³ and −10×10⁻³, and a volume of between about −2550×10⁻³ mm² and −760×10⁻³ mm² over substantially the entire length of the glassmaker's tube (e.g., about 70 percent or more). The refractive index and the volume of the trench can be well controlled using the method according to the invention. In particular, over substantially the entire length of the glassmaker's tube (e.g., about 70 percent or more, such as about 75-95 percent), the buried trench's refractive index difference has a longitudinal variation of less than 10 percent, and the buried trench's volume has a longitudinal variation of less than 15 percent.

Such a glassmaker's tube may be used as a starting tube for fabricating a primary preform by chemical vapor deposition (CVD). Once the deposition has been performed inside such a tube, the primary preform is built out or a sleeve is fitted thereto in order to produce a final preform, and an optical fiber may be drawn from the final preform.

To supplement the present disclosure, this application incorporates entirely by reference the following commonly assigned patents, patent application publications, and patent applications: U.S. Pat. No. 4,838,643 for a Single Mode Bend Insensitive Fiber for Use in Fiber Optic Guidance Applications (Hodges et al.); U.S. Pat. No. 7,623,747 for a Single Mode Optical Fiber (de Montmorillon et al.); U.S. Pat. No. 7,587,111 for a Single-Mode Optical Fiber (de Montmorillon et al.); U.S. Pat. No. 7,356,234 for a Chromatic Dispersion Compensating Fiber (de Montmorillon et al.); U.S. Pat. No. 7,483,613 for a Chromatic Dispersion Compensating Fiber (Bigot-Astruc et al.); U.S. Pat. No. 7,526,177 for a Fluorine-Doped Optical Fiber (Matthijsse et al.); U.S. Pat. No. 7,555,186 for an Optical Fiber (Flammer et al.); U.S. Patent Application Publication No. US2009/0252469 A1 for a Dispersion-Shifted Optical Fiber (Sillard et al.); U.S. Patent Application Publication No. US2011/0044595 A1 for a Transmission Optical Fiber Having Large Effective Area (Sillard et al.); International Patent Application Publication No. WO 2009/062131 A1 for a Microbend-Resistant Optical Fiber, (Overton); U.S. Patent Application Publication No. US2009/0175583 A1 for a Microbend-Resistant Optical Fiber, (Overton); U.S. Patent Application Publication No. US2009/0279835 A1 for a Single-Mode Optical Fiber Having Reduced Bending Losses, filed May 6, 2009, (de Montmorillon et al.); U.S. Pat. No. 7,889,960 for a Bend-Insensitive Single-Mode Optical Fiber, (de Montmorillon et al.); U.S. Patent Application Publication No. US2010/0021170 A1 for a Wavelength Multiplexed Optical System with Multimode Optical Fibers, filed Jun. 23, 2009, (Lumineau et al.); U.S. Patent Application Publication No. US2010/0028020 A1 for a Multimode Optical Fibers, filed Jul. 7, 2009, (Gholami et al.); U.S. Patent Application Publication No. US2010/0119202 A1 for a Reduced-Diameter Optical Fiber, filed Nov. 6, 2009, (Overton); U.S. Patent Application Publication No. US2010/0142969 A1 for a Multimode Optical System, filed Nov. 6, 2009, (Gholami et al.); U.S. Patent Application Publication No. US2010/0118388 A1 for an Amplifying Optical Fiber and Method of Manufacturing, filed Nov. 12, 2009, (Pastouret et al.); U.S. Patent Application Publication No. US2010/0135627 A1 for an Amplifying Optical Fiber and Production Method, filed Dec. 2, 2009, (Pastouret et al.); U.S. Patent Application Publication No. US2010/0142033 for an Ionizing Radiation-Resistant Optical Fiber Amplifier, filed Dec. 8, 2009, (Regnier et al.); U.S. Patent Application Publication No. US2010/0150505 A1 for a Buffered Optical Fiber, filed Dec. 11, 2009, (Testu et al.); U.S. Patent Application Publication No. US2010/0171945 for a Method of Classifying a Graded-Index Multimode Optical Fiber, filed Jan. 7, 2010, (Gholami et al.); U.S. Patent Application Publication No. US2010/0189397 A1 for a Single-Mode Optical Fiber, filed Jan. 22, 2010, (Richard et al.); U.S. Patent Application Publication No. US2010/0189399 A1 for a Single-Mode Optical Fiber Having an Enlarged Effective Area, filed Jan. 27, 2010, (Sillard et al.); U.S. Patent Application Publication No. US2010/0189400 A1 for a Single-Mode Optical Fiber, filed Jan. 27, 2010, (Sillard et al.); U.S. Patent Application Publication No. US2010/0214649 A1 for an Optical Fiber Amplifier Having Nanostructures, filed Feb. 19, 2010, (Burov et al.); U.S. Patent Application Publication No. US2010/0254653 A1 for a Multimode Fiber, filed Apr. 22, 2010, (Molin et al.); U.S. Patent Application Publication No. US2010/0310218 A1 for a Large Bandwidth Multimode Optical Fiber Having a Reduced Cladding Effect, filed Jun. 4, 2010, (Molin et al.); U.S. Patent Application Publication No. US2011/0058781 A1 for a Multimode Optical Fiber Having Improved Bending Losses, filed Sep. 9, 2010, (Molin et al.); U.S. Patent Application Publication No. US2011/0064367 A1 for a Multimode Optical Fiber, filed Sep. 17, 2010, (Molin et al.); U.S. Patent Application Publication No. US2011/0069724 A1 for an Optical Fiber for Sum-Frequency Generation, filed Sep. 22, 2010, (Richard et al.); U.S. Patent Publication No. US2011/0116160 A1 for a Rare-Earth-Doped Optical Fiber Having Small Numerical Aperture, filed Nov. 11, 2010, (Boivin et al.); U.S. Patent Publication No. US2011/0123161 A1 for a High-Bandwidth, Multimode Optical Fiber with Reduced Cladding Effect, filed Nov. 24, 2010, (Molin et al.); U.S. Patent Publication No. US2011/0123162 A1 for a High-Bandwidth, Dual-Trench-Assisted Multimode Optical Fiber, filed Nov. 24, 2010, (Molin et al.); U.S. Patent Publication No. US2011/0135262 A1 for a Multimode Optical Fiber with Low Bending Losses and Reduced Cladding Effect, filed Dec. 3, 2010, (Molin et al.); U.S. Patent Publication No. US2011/0135263 A1 for a High-Bandwidth Multimode Optical Fiber Having Reduced Bending Losses, filed Dec. 3, 2010, (Molin et al.); U.S. Patent Publication No. US2011/0188826 A1 for a Non-Zero Dispersion Shifted Optical Fiber Having a Large Effective Area, filed Jan. 31, 2011, (Sillard et al.); U.S. Patent Publication No. US2011/0188823 A1 for a Non-Zero Dispersion Shifted Optical Fiber Having a Short Cutoff Wavelength, filed Jan. 31, 2011, (Sillard et al.); U.S. Patent Application No. 13/037,943 for a Broad-Bandwidth Multimode Optical Fiber Having Reduced Bending Losses, filed Mar. 1, 2011, (Bigot-Astruc et al.); U.S. patent application No. 13/048,028 for a Single-Mode Optical Fiber, filed Mar. 15, 2011, (de Montmorillon et al.); and U.S. patent application No. 13/175,181 for a Single-Mode Optical Fiber, filed Jul. 1, 2011, (Bigot-Astruc et al.).

To supplement the present disclosure, this application further incorporates entirely by reference the following commonly assigned patents, patent application publications, and patent applications: U.S. Pat. No. 5,574,816 for Polypropylene-Polyethylene Copolymer Buffer Tubes for Optical Fiber Cables and Method for Making the Same; U.S. Pat. No. 5,717,805 for Stress Concentrations in an Optical Fiber Ribbon to Facilitate Separation of Ribbon Matrix Material; U.S. Pat. No. 5,761,362 for Polypropylene-Polyethylene Copolymer Buffer Tubes for Optical Fiber Cables and Method for Making the Same; U.S. Pat. No. 5,911,023 for Polyolefin Materials Suitable for Optical Fiber Cable Components; U.S. Pat. No. 5,982,968 for Stress Concentrations in an Optical Fiber Ribbon to Facilitate Separation of Ribbon Matrix Material; U.S. Pat. No. 6,035,087 for an Optical Unit for Fiber Optic Cables; U.S. Pat. No. 6,066,397 for Polypropylene Filler Rods for Optical Fiber Communications Cables; U.S. Pat. No. 6,175,677 for an Optical Fiber Multi-Ribbon and Method for Making the Same; U.S. Pat. No. 6,085,009 for Water Blocking Gels Compatible with Polyolefin Optical Fiber Cable Buffer Tubes and Cables Made Therewith; U.S. Pat. No. 6,215,931 for Flexible Thermoplastic Polyolefin Elastomers for Buffering Transmission Elements in a Telecommunications Cable; U.S. Pat. No. 6,134,363 for a Method for Accessing Optical Fibers in the Midspan Region of an Optical Fiber Cable; U.S. Pat. No. 6,381,390 for a Color-Coded Optical Fiber Ribbon and Die for Making the Same; U.S. Pat. No. 6,181,857 for a Method for Accessing Optical Fibers Contained in a Sheath; U.S. Pat. No. 6,314,224 for a Thick-Walled Cable Jacket with Non-Circular Cavity Cross Section; U.S. Pat. No. 6,334,016 for an Optical Fiber Ribbon Matrix Material Having Optimal Handling Characteristics; U.S. Pat. No. 6,321,012 for an Optical Fiber Having Water Swellable Material for Identifying Grouping of Fiber Groups; U.S. Pat. No. 6,321,014 for a Method for Manufacturing Optical Fiber Ribbon; U.S. Pat. No. 6,210,802 for Polypropylene Filler Rods for Optical Fiber Communications Cables; U.S. Pat. No. 6,493,491 for an Optical Drop Cable for Aerial Installation; U.S. Pat. No. 7,346,244 for a Coated Central Strength Member for Fiber Optic Cables with Reduced Shrinkage; U.S. Pat. No. 6,658,184 for a Protective Skin for Optical Fibers; U.S. Pat. No. 6,603,908 for a Buffer Tube that Results in Easy Access to and Low Attenuation of Fibers Disposed Within Buffer Tube; U.S. Pat. No. 7,045,010 for an Applicator for High-Speed Gel Buffering of Flextube Optical Fiber Bundles; U.S. Pat. No. 6,749,446 for an Optical Fiber Cable with Cushion Members Protecting Optical Fiber Ribbon Stack; U.S. Pat. No. 6,922,515 for a Method and Apparatus to Reduce Variation of Excess Fiber Length in Buffer Tubes of Fiber Optic Cables; U.S. Pat. No. 6,618,538 for a Method and Apparatus to Reduce Variation of Excess Fiber Length in Buffer Tubes of Fiber Optic Cables; U.S. Pat. No. 7,322,122 for a Method and Apparatus for Curing a Fiber Having at Least Two Fiber Coating Curing Stages; U.S. Pat. No. 6,912,347 for an Optimized Fiber Optic Cable Suitable for Microduct Blown Installation; U.S. Pat. No. 6,941,049 for a Fiber Optic Cable Having No Rigid Strength Members and a Reduced Coefficient of Thermal Expansion; U.S. Pat. No. 7,162,128 for Use of Buffer Tube Coupling Coil to Prevent Fiber Retraction; U.S. Pat. No. 7,515,795 for a Water-Swellable Tape, Adhesive-Backed for Coupling When Used Inside a Buffer Tube (Overton et al.); U.S. Patent Application Publication No. 2008/0292262 for a Grease-Free Buffer Optical Fiber Buffer Tube Construction Utilizing a Water-Swellable, Texturized Yarn (Overton et al.); European Patent Application Publication No. 1,921,478 A1, for a Telecommunication Optical Fiber Cable (Tatat et al.); U.S. Pat. No. 7,702,204 for a Method for Manufacturing an Optical Fiber Preform (Gonnet et al.); U.S. Pat. No. 7,570,852 for an Optical Fiber Cable Suited for Blown Installation or Pushing Installation in Microducts of Small Diameter (Nothofer et al.); U.S. Pat. No. 7,646,954 for an Optical Fiber Telecommunications Cable (Tatat); U.S. Pat. No. 7,599,589 for a Gel-Free Buffer Tube with Adhesively Coupled Optical Element (Overton et al.); U.S. Pat. No. 7,567,739 for a Fiber Optic Cable Having a Water-Swellable Element (Overton); U.S. Pat. No. 7,817,891 for a Method for Accessing Optical Fibers within a Telecommunication Cable (Lavenne et al.); U.S. Pat. No. 7,639,915 for an Optical Fiber Cable Having a Deformable Coupling Element (Parris et al.); U.S. Pat. No. 7,646,952 for an Optical Fiber Cable Having Raised Coupling Supports (Parris); U.S. Pat. No. 7,724,998 for a Coupling Composition for Optical Fiber Cables (Parris et al.); U.S. Patent Application Publication No. US2009/0214167 A1 for a Buffer Tube with Hollow Channels, (Lookadoo et al.); U.S. Patent Application Publication No. US2009/0297107 A1 for an Optical Fiber Telecommunication Cable, filed May 15, 2009, (Tatat); U.S. Patent Application Publication No. US2009/0279833 A1 for a Buffer Tube with Adhesively Coupled Optical Fibers and/or Water-Swellable Element, filed Jul. 21, 2009, (Overton et al.); U.S. Patent Application Publication No. US2010/0092135 A1 for an Optical Fiber Cable Assembly, filed Sep. 10, 2009, (Barker et al.); U.S. Pat. No. 7,974,507 A1 for a High-Fiber-Density Optical Fiber Cable (Louie et al.); U.S. Pat. No. 7,970,247 for a Buffer Tubes for Mid-Span Storage (Barker); U.S. Patent Application Publication No. US2010/0135623 A1 for Single-Fiber Drop Cables for MDU Deployments, filed Nov. 9, 2009, (Overton); U.S. Patent Application Publication No. US2010/0092140 A1 for an Optical-Fiber Loose Tube Cables, filed Nov. 9, 2009, (Overton); U.S. Patent Application Publication No. US2010/0135624 A1 for a Reduced-Size Flat Drop Cable, filed Nov. 9, 2009, (Overton et al.); U.S. Patent Application Publication No. US2010/0092138 A1 for ADSS Cables with High-Performance Optical Fiber, filed Nov. 9, 2009, (Overton); U.S. Patent Application Publication No. US2010/0135625 A1 for Reduced-Diameter Ribbon Cables with High-Performance Optical Fiber, filed Nov. 10, 2009, (Overton); U.S. Patent Application Publication No. US2010/0092139 A1 for a Reduced-Diameter, Easy-Access Loose Tube Cable, filed Nov. 10, 2009, (Overton); U.S. Patent Application Publication No. US2010/0154479 A1 for a Method and Device for Manufacturing an Optical Preform, filed Dec. 19, 2009, (Milicevic et al.); U.S. Patent Application Publication No. US 2010/0166375 for a Perforated Water-Blocking Element, filed Dec. 29, 2009, (Parris); U.S. Patent Application Publication No. US2010/0183821 A1 for a UVLED Apparatus for Curing Glass-Fiber Coatings, filed Dec. 30, 2009, (Hartsuiker et al.); U.S. Patent Application Publication No. US2010/0202741 A1 for a Central-Tube Cable with High-Conductivity Conductors Encapsulated with High-Dielectric-Strength Insulation, filed Feb. 4, 2010, (Ryan et al.); U.S. Patent Application Publication No. US2010/0215328 A1 for a Cable Having Lubricated, Extractable Elements, filed Feb. 23, 2010, (Tatat et al.); U.S. Patent Application Publication No. US2011/0026889 A1 for a Tight-Buffered Optical Fiber Unit Having Improved Accessibility, filed Jul. 26, 2010, (Risch et al.); U.S. Patent Application Publication No. US2011/0064371 A1 for Methods and Devices for Cable Insertion into Latched Conduit, filed Sep. 14, 2010, (Leatherman et al.); U.S. Patent Publication No. 2011/0069932 A1 for a High-Fiber-Density Optical-Fiber Cable, filed Oct. 19, 2010, (Overton et al.); U.S. Patent Publication No. 2011/0091171 A1 for an Optical-Fiber Cable Having High Fiber Count and High Fiber Density, filed Oct. 19, 2010, (Tatat et al.); U.S. Patent Publication No. 2011/0176782 A1 for a Water-Soluble Water-Blocking Element, filed Jan. 19, 2011, (Parris); U.S. patent application Ser. No. 13/096,178 for a Data-Center Cable, filed Apr. 28, 2011, (Lovie et al.); U.S. patent application Ser. No. 13/099,663 for a Bundled Fiber Optic Cables, filed May 3, 2011, (Quinn et al.); U.S. patent application Ser. No. 13/111,147 for a Curing Apparatus Employing Angled UVLEDs, filed May 19, 2011, (Molin); U.S. patent application Ser. No. 13/116,141 for a Low-Smoke and Flame-Retardant Fiber Optic Cables, filed May 26, 2011, (Lovie et al.); U.S. patent application Ser. No. 13/152,651 for a Curing Apparatus Having UV Sources That Emit Differing Ranges of UV Radiation, filed Jun. 3, 2011, (Gharbi et al.); U.S. patent application Ser. No. 13/181,762 for a Adhesively Coupled Optical Fibers and Enclosing Tape, filed Jul. 13, 2011, (Parris); and U.S. patent application Ser. No. 13/206,601 for a Method and Apparatus Providing Increased UVLED Intensity, filed Aug. 10, 2011, (Overton).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A method of fabricating an optical fiber preform having a central core surrounded by an intermediate cladding, a buried trench surrounding the intermediate cladding, and an outer cladding surrounding the buried trench, the method comprising:
depositing silica for the central core on the interior of a first deposition tube via a chemical vapor deposition, and then preparing a first rod from the first deposition tube;
depositing silica for the buried trench on the interior of a second deposition tube via a chemical vapor deposition, and then preparing a second rod from the second deposition tube; and
thereafter fitting the second rod as a sleeve on the first rod to form a primary preform.

2. The method of claim 1, wherein the step of depositing silica for the buried trench comprises depositing silica via plasma-assisted chemical vapor deposition (PCVD).

3. The method of claim 1, wherein the step of depositing silica for the central core comprises depositing silica via modified chemical vapor deposition (MCVD), furnace-assisted chemical vapor deposition (FCVD), and/or plasma-assisted chemical vapor deposition (PCVD).

4. The method of claim 1, comprising stretching the first rod before fitting the second rod as a sleeve on the first rod.

5. The method of claim 1, comprising chemically etching a portion of the first deposition tube before fitting the second rod as a sleeve on the first rod.

6. The method of claim 1, comprising overcladding and/or sleeving the second rod to achieve an optical fiber preform having an outer diameter of about 140 millimeters or more.

7. The method of claim 6, wherein:
the cross-sectional area of deposition in the first rod is about 700 mm² or less; and
the cross-sectional area of deposition in the second rod is about 700 mm² or less.

8. The method of claim 1, wherein the step of depositing silica for the buried trench comprises depositing dopants at a controlled concentration such that the buried trench has a refractive index difference relative to the outer cladding of between about −4×10⁻³ and −10×10⁻³.

9. The method of claim 8, wherein the step of depositing dopants comprises depositing dopants at a controlled concentration such that the buried trench's refractive index difference has a longitudinal variation of less than 10 percent over substantially the entire length of the second rod.

10. The method of claim 1, wherein the step of depositing silica for the buried trench comprises depositing silica until the cross-sectional area of the deposited buried trench is between about 300 mm² and 700 mm² as measured in the second deposition tube.

11. The method of claim 10, wherein the step of depositing silica for the buried trench comprises depositing silica in a controlled way such that the buried trench's cross-sectional area has a longitudinal variation of less than 10 percent over substantially the entire length of the second rod.

12. The method of claim 1, wherein the step of depositing silica for the buried trench comprises depositing dopants at a concentration and a thickness until the buried trench has a volume of between about −2550×10⁻³ mm² and −760×10⁻³ mm² as measured in the second deposition tube.

13. The method of claim 12, wherein the step of depositing dopants comprises depositing dopants such that the buried trench's volume has a longitudinal variation of less than 15 percent over substantially the entire length of the second rod.

14. The method of claim 1, comprising, before the step of preparing the first rod, depositing silica for the intermediate cladding on the interior of the first deposition tube via a chemical vapor deposition.

15. The method of claim 14, comprising, before the step of preparing the second rod, depositing silica for the intermediate cladding on the interior of the second deposition tube via a chemical vapor deposition.

16. The method of claim 1, wherein no silica for the central core is deposited within the second deposition tube.

17. The method of claim 1, comprising:
overcladding and/or sleeving the primary preform to form an optical fiber preform; and
then drawing an optical fiber from the optical fiber preform in a fiber-drawing tower.

18. An optical fiber preform, comprising:
a central core;
an intermediate cladding surrounding the central core;
a buried trench surrounding the intermediate cladding; and
an outer cladding surrounding the buried trench;
wherein the buried trench has a refractive index difference relative to the outer cladding of between about −4×10⁻³ and −10×10⁻³ with longitudinal variation of less than 10 percent over substantially the entire length of the optical fiber preform; and
wherein the buried trench has a volume of between about −2550×10⁻³ mm² and −760×10⁻³ mm² with longitudinal variation of less than 15 percent over substantially the entire length of the optical fiber preform.

19. The optical fiber preform according to claim 18, wherein the buried trench has a cross-sectional area of between about 300 mm² and 700 mm².

20. The optical fiber preform according to claim 19, wherein the buried trench's cross-sectional area has a longitudinal variation of less than 10 percent over substantially the entire length of the optical fiber preform.

21. The optical fiber preform according to claim 18, wherein the optical fiber preform has an outer diameter of about 140 millimeters or more.

22. The optical fiber preform according to claim 18, wherein the central core has a refractive index difference relative to the outer cladding of between about 4×10⁻³ and 6×10⁻³.

23. The optical fiber preform according to claim 18, wherein the central core has a refractive index difference relative to the intermediate cladding of between about 4×10⁻³ and 6×10⁻³.

24. A glassmaker's tube, comprising:
a buried trench surrounded by an outer cladding;
wherein the buried trench has a refractive index difference relative to the outer cladding of between about −4×10⁻³ and −10×10⁻³ with longitudinal variation of less than 10 percent over substantially the entire length of the glassmaker's tube;
wherein the buried trench has a volume of between about −2550×10³ mm² and −760×10³ mm² with longitudinal variation of less than 15 percent over substantially the entire length of the glassmaker's tube; and
wherein the glassmaker's tube has an inner diameter of between about 16 millimeters and 35 millimeters.

25. The glassmaker's tube according to claim 24, wherein the buried trench has a cross-sectional area of between about 300 mm² and 700 mm².

26. The glassmaker's tube according to claim 25, wherein the buried trench's cross-sectional area has a longitudinal variation of less than 10 percent over substantially the entire length of the glassmaker's tube.

27. A method of fabricating an optical fiber, comprising fabricating a primary preform by chemical vapor deposition (CVD) in the glassmaker's tube according to claim 24;
overcladding or sleeving the primary preform to form an optical fiber preform; and
drawing an optical fiber from the optical fiber preform in a fiber-drawing tower.
